(19) United States
(12) Patent Application Publication
(10) Pub. No.: US 2026/0159428 A1
(43) Pub. Date: Jun. 11, 2026

(54) IN-SITU INTEGRATED DEVICE FOR PURIFYING VOCS IN GROUNDWATER AND AN APPLICATION METHOD THEREOF

(71) Applicant: Chinese Research Academy of Environmental Sciences, Beijing (CN)

(72) Inventors: Fanyang BU, Beijing (CN); Fujun MA, Beijing (CN); Qingbao GU, Beijing (CN)

(21) Appl. No.: 19/287,867

(22) Filed: Aug. 1, 2025

(30) Foreign Application Priority Data
Dec. 10, 2024 (CN) 202411805860.2

(51) Int. Cl. C02F 9/00; B01D 53/04; B01J 20/20; B01J 20/28; B01J 20/34; B09C 1/00; C02F 1/00; C02F 1/20; C02F 1/66; C02F 1/70; C02F 1/72; C02F 101/32; C02F 103/06

(52) U.S. Cl. CPC C02F 9/00; B01D 53/0423; B01J 20/20; B01J 20/28004; B01J 20/3416; B01J 20/3458; B09C 1/002; B01D 2253/102; B01D 2253/304; B01D 2257/708; B01D 2259/4009; B09C 1/005; C02F 1/008; C02F 1/20; C02F 1/66; C02F 1/70; C02F 1/72; C02F 2101/322; C02F 2103/06; C02F 2201/005; C02F 2209/006; C02F 2209/38; C02F 2209/42

(57) ABSTRACT

An integrated in-situ purification device for VOCs in groundwater includes an integrated pneumatic pump for in-situ air stripping-aeration-reagent dosing, a groundwater extraction well, a reagent dosing pipe, a ground reagent dosing device, a pneumatic pump access pipe, a ground tail gas treatment device, a fan, and a gas phase extraction device. By connecting the integrated pneumatic pump for in-situ air stripping-aeration-reagent dosing with the ground tail gas treatment device, the present application realizes the cyclic utilization of tail gas within the system, reduces the high dependence on tail gas treatment processes, and lowers the operation, maintenance and detection costs of equipment.

### CROSS-REFERENCE TO RELATED APPLICATIONS

This application claims priority to Chinese Patent Application No. 202411805860.2, filed on Dec. 10, 2024, the entire disclosure of which is incorporated herein by reference.

### TECHNICAL FIELD

The present application relates to the technical field of in-situ remediation of soil and groundwater, and specifically relates to an in-situ integrated device for purifying VOCs in groundwater and an application method thereof.

### BACKGROUND

When underground aquifers contaminated by organic matters, especially those polluted by volatile organic compounds (VOCs) such as petroleum hydrocarbons, chlorinated hydrocarbons, and benzene series, in-situ treatment technologies including groundwater extraction and treatment, and groundwater aeration treatment, have been widely applied due to their remarkable treatment effects and economic advantages.

The groundwater extraction and treatment technology involves arranging groundwater extraction wells in the target aquifer, pumping contaminated groundwater to the surface with water pumps, and then purifying it using various treatment technologies for reuse or re-injection into the ground. The air stripping plus activated carbon adsorption process is extremely widely used in the sewage treatment process after extraction in the groundwater extraction and treatment process. For example, A patent CN118652016B discloses a contaminated groundwater extraction and treatment device and process. The treatment device includes a base, and an extraction component, a stripping deodorization component, and an electrocatalytic oxidation component provided on the base. The extraction component is responsible for pumping a sewage accumulated in the underground well into the stripping deodorization component, which converts odor pollutants in the sewage into a gas phase and discharges them from the device. The electrocatalytic oxidation component oxidizes and decomposes pollutants such as benzene, carbon tetrachloride, chlorobenzene, chloroform, and 4-chlorodiphenyl ether in the sewage into small-molecule substances, allowing the pollutants to be discharged from the device, thus achieving extraction and treatment of contaminated groundwater. The device of this invention has a reasonable structural design, which can effectively remove odor substances in sewage, prevent further deterioration of the surrounding environment by contaminated groundwater, and simultaneously uses the electrocatalytic oxidation component to oxidize and decompose specific pollutants, improving the safety of sewage discharge.

As an in-situ remediation technology for treating organic pollution in soil and groundwater, groundwater aeration technology injects pressurized air below the saturated aquifer, prompting organic pollutants to be converted into volatile pollutants through interphase mass transfer (dissolution, volatilization, desorption, biodegradation, etc.), which then migrate with the air flow to the vadose zone and are collected by other air extraction devices to surface gas treatment device. Early groundwater aeration technology was greatly limited by formation conditions in its application scenarios because it required arranging a certain number of air extraction wells in the vadose zone above the saturated layer to collect organic vapors generated by groundwater aeration for treatment. To improve adaptability, an in-well aeration method was developed through improvement, that is, groundwater flows into the well, undergoes in-well stripping and aeration, the volatilized vapor is extracted by a negative pressure fan into the aboveground tail gas treatment device for treatment, and the preliminarily purified groundwater further undergoes mass transfer with the surrounding groundwater through concentration gradients and other effects. For example, the invention patent CN109047302B discloses an in-situ aeration remediation method for VOCs-contaminated groundwater in low-permeability zones. Based on the surfactant-enhanced aeration remediation method, it uses point-adjustable hydraulic fracturing technology to perform multi-point hydraulic fracturing on the low-permeability contaminated zone, generating a large number of artificial fractures in the area. Meanwhile, the pressure solution used for fracturing is a surfactant solution, which enhances the gas permeability of the low-permeability contaminated zone, strengthens the desorption capacity of pollutants from fine-grained soil, and effectively solves the problem that low-permeability contaminated zones are difficult to remediate. This method uses hydraulic fracturing technology in conjunction with the strengthening effect of surfactants on the basis of traditional groundwater aeration to enhance the desorption of pollutants in low-permeability formations and improve treatment efficiency.

However, although the above inventions have improved the application effects of groundwater extraction plus aeration and in-situ groundwater aeration technologies in the field of groundwater remediation to a certain extent, they both have the problem of qualified tail gas discharge. In the above repair processes, the tail gas treatment device cannot achieve internal circulation of the gas system, and the polluted gas needs to be discharged after being treated by the tail gas treatment device, which requires the tail gas to meet relevant emission standards. This puts forward high requirements for the tail gas treatment process and increases the costs of device operation, maintenance, and detection. Therefore, it is necessary to propose an in-situ integrated device for purifying VOCs in groundwater and an application method thereof to solve the problems in the related art.

### SUMMARY

The object of the present application is to address the deficiencies of the related art by providing an in-situ integrated device for purifying VOCs in groundwater and an application method thereof, which enables the recycling of tail gas, reduces heavy reliance on tail gas treatment processes, lowers device operation, maintenance, and detection costs, avoids direct emission of tail gas into the environment, and significantly reduces potential pollution risks to the surrounding environment.

To solve the above technical problems, the present application provides the following technical solutions: An in-situ purification integrated device for volatile organic compounds (VOCs) in groundwater, comprising
an in-situ air stripping-aeration-reagent dosing integrated pneumatic pump, a groundwater extraction well, a reagent dosing pipe, a ground reagent dosing device, a pneumatic pump access pipe, a ground tail gas treatment device, a fan, and a gas phase extraction device;
wherein the in-situ air stripping-aeration-reagent dosing integrated pneumatic pump is gas-driven, an air inlet of the in-situ air stripping-aeration-reagent dosing integrated pneumatic pump is connected to the fan through a pipeline, the fan is connected to the ground tail gas treatment device through the pipeline to receive treated tail gas as a power source;
an end of the reagent dosing pipe is connected to the ground reagent dosing device, and another end of the reagent dosing pipe is communicated with the in-situ air stripping-aeration-reagent dosing integrated pneumatic pump, and a reagent dosing rate is controlled by an opening size of a solenoid valve in the ground reagent dosing device, and a control signal of the solenoid valve is generated and transmitted by a computer program;
the pneumatic pump access pipe is connected to the in-situ air stripping-aeration-reagent dosing integrated pneumatic pump, and is connected to a high-temperature air source, a flow regulating valve is provided on the pneumatic pump access pipe; and
the ground tail gas treatment device is connected to each extraction well pipe through the pipeline, and is internally provided with an activated carbon adsorption tank filled with columnar activated carbon with a particle size of 3-5 mm, and the gas treated by the activated carbon adsorption tank is pressurized and heated by the fan and then pumped back into the in-situ air stripping-aeration-reagent dosing integrated pneumatic pump.

Compared with the related art, the in-situ integrated device for purifying VOCs in groundwater and its application method have the following beneficial effects:

First, the present application connects the in-situ air stripping-aeration-reagent dosing integrated pneumatic pump with the ground tail gas treatment device, so that the tail gas purified by the tail gas treatment device is pressurized and heated by a fan and then re-pumped into the pneumatic pump as a power source, thereby realizing the recycling of tail gas within the system, reducing the high dependence on tail gas treatment processes, and thus lowering the operation, maintenance, and detection costs of the device. Since the tail gas circulates inside the system, direct emission of tail gas to the outside is avoided, significantly reducing the potential pollution risk to the surrounding environment, which achieves a more environmentally friendly groundwater purification process, complies with environmental protection requirements, and reduces the probability of environmental problems and related environmental incidents caused by tail gas emissions.

Second, the reagent dosing pipe of the present application is connected to the ground reagent dosing device, which enables precise adjustment of the reagent dosage according to the actual conditions such as the pollution degree of groundwater and the characteristics of the aquifer during the remediation process, realizing precise remediation. Reagent dosing can be carried out simultaneously with aeration. At this time, the reagent is mixed with groundwater and air in the pipeline and then sprayed, seeping back into the original formation under the dual action of hydraulic pressure and air pressure, and realizing the dosing and mixing of the reagent through hydraulic circulation, and it can also be carried out separately, the fan extracts ambient air and injects it into the well to pump the groundwater and reagent to the upper screen section and then quickly discharge them, accelerating the reagent dosing process. This diversified dosing mode can be flexibly selected according to actual remediation needs, realizing the synergistic effect of aeration flushing and treatment methods such as oxidation/reduction/microbial treatment, and can provide a more comprehensive and effective groundwater purification solution for different pollution scenarios and remediation targets.

Other advantages, objectives, and features of the present application will be described to some extent in the subsequent specification, and to some extent, will be obvious to those skilled in the art based on the study of the following text, or can be learned from the practice of the present application.

### BRIEF DESCRIPTION OF THE DRAWINGS

To more clearly illustrate the technical solutions in the embodiments of the present application or the related art, the following briefly introduces the drawings required in the description of the embodiments or the related art. Obviously, the drawings described below are only some embodiments of the present application, and those skilled in the art can also obtain other drawings based on these drawings without creative efforts.

FIG. 1 is a schematic diagram of the overall structure of the in-situ integrated device for purifying VOCs in groundwater;

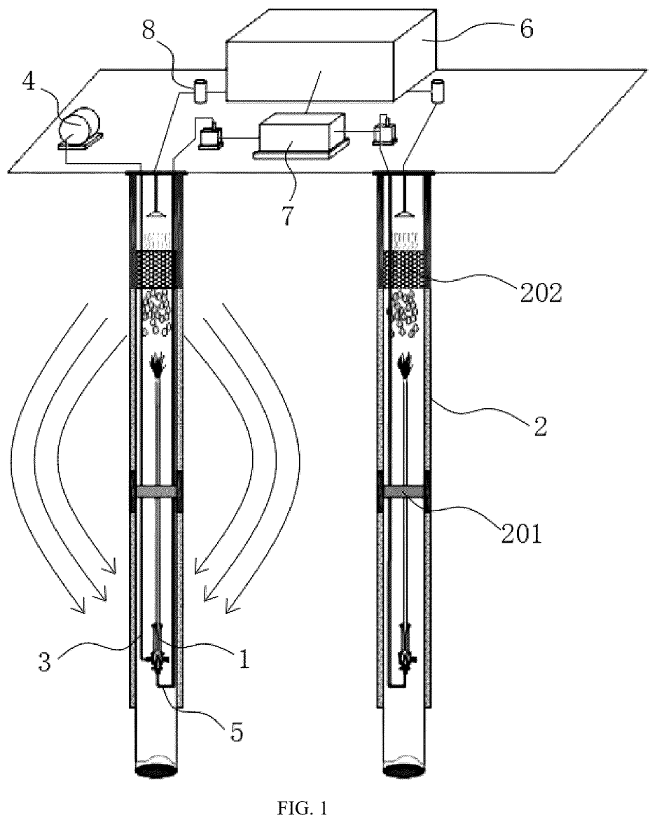

FIG. 2 is a schematic diagram of the structure of the in-situ air stripping-aeration-reagent dosing integrated pneumatic pump.

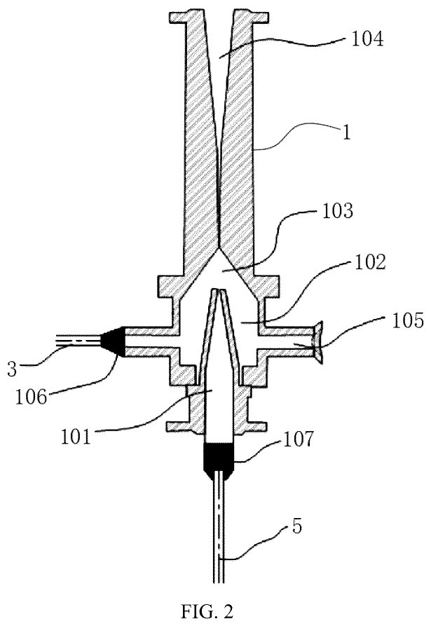

### DETAILED DESCRIPTION OF THE EMBODIMENTS

The technical solutions in the embodiments of the present application will be clearly and completely described below. Obviously, the described embodiments are only part of the embodiments of the present application, rather than all of them. Based on the embodiments of the present application, all other embodiments obtained by those skilled in the art without creative efforts shall fall within the protection scope of the present application.

### Embodiment 1: Pumping and Aeration of Groundwater

First, the device for in-situ purification of volatile organic compounds (VOCs) in groundwater is carefully assembled. The groundwater extraction well 2 adopts a customized stainless steel double-layer well pipe. The slits of its inner 304 stainless steel slotted pipe are in a carefully designed spiral shape, the width is strictly adjusted to 0.3 mm, the slit spacing is precisely set to 8 mm, the length is determined to be 10 cm, and adjacent slits are staggered by 45 degrees to ensure that groundwater can efficiently and uniformly enter the extraction pipe. The outer stainless steel wire mesh structure is tightly wrapped, and the space between the two layers is filled with 2.5 mm quartz sand that has undergone strict screening and cleaning to effectively prevent impurities from mixing into the groundwater and affecting the treatment effect. The middle barrier 201 is made of 5 mm thick high-quality rubber, which fits closely with the inner wall of the well pipe. The annular sealing grooves on the upper and lower surfaces are equipped with high-elasticity rubber sealing rings with a Shore hardness of 55 degrees to ensure the water tightness of the middle barrier 201 and perfectly separate the upper and lower parts of the well pipe. The upper filter screen 202 is formed by stacking 5 mm thick stainless steel multi-layer wire meshes, and the mesh apertures are 0.5 mm, 0.3 mm, and 0.1 mm from the inside to the outside in sequence, forming an effective aperture gradient to maximize the interception of high-speed ejected water vapor and prevent it from entering the tail gas treatment system.

The fan 7 and the gas phase extraction device 8 are started, and the initial rotation speed of the fan 7 is set to 1200 rpm to extract the volatile polluted gas in the groundwater to the ground tail gas treatment device 6. The activated carbon adsorption tank in the ground tail gas treatment device 6 starts to work efficiently to strongly adsorb and purify the polluted gas. The activated carbon adsorption tank is filled with 4 mm columnar activated carbon that has undergone special activation treatment, with a specific surface area of 1200 m²/g, and is provided with a gas distribution plate at the bottom. The ventilation holes have a diameter of 3 mm and are provided in a regular triangle. And the automatic pressure compensation device of extraction pipeline of the fan 7 extracts ambient air. When the system air volume is monitored to reach balance by an air volume sensor with an accuracy of ±5 m³/h provided on the pipeline, the extraction of ambient air is automatically closed, the rotation speed of the fan 7 is adjusted to 1000 rpm, and the tail gas internal circulation is started.

The tail gas treated by the ground tail gas treatment device 6 is pressurized to 0.3 MPa and heated to 80° C. by the booster fan 7 and then transported to the in-situ air stripping-aeration-reagent dosing integrated pneumatic pump 1. The high-pressure gas enters the pneumatic pump to generate negative pressure, and the groundwater in the lower layer of the groundwater extraction well 2 is extracted to the upper layer through the air stripping extraction pipe. By adjusting the gas flow regulating valve of the pneumatic pump, the upward flow rate of water in the well is precisely maintained at 1.5 m/s.

The upper filter screen 202 of the well pipe intercepts the high-speed ejected water vapor to prevent it from being sucked into the ground tail gas treatment device 6 by the gas phase extraction device 8. After the pollutants volatilize, they are sucked away by a high-efficiency vacuum pump with an extraction rate of 8 m³/min and a vacuum degree of up to 0.085 MPa and enter the tail gas treatment device for recycling. Under the action of gravity and micro positive pressure, water seeps from the upper screen pipe, migrates downward under the action of gravity, and enters the lower screen pipe under the action of water head to form a stable cycle. The micro positive pressure is monitored by a pressure sensor with an accuracy of ±0.01 MPa provided in the upper part of the well pipe. In this process, each time after aeration and circulation treatment, the residence time of groundwater in the aquifer is 3 hours to fully carry out mass transfer and pollutant removal. And multiple temperature sensors with an accuracy of ±0.5° C. and water quality monitoring points are set at different depths of the aquifer to comprehensively monitor temperature and water quality changes in real time, so as to timely and accurately adjust operation parameters.

In the operation process, the change of the groundwater level is accurately monitored in real time by a water level sensor with an accuracy of ±0.05 m provided in the well. If the water level drops by more than 0.5 m, the power of the fan 7 and the pneumatic pump is appropriately reduced to prevent excessive extraction of groundwater. And the concentration of VOCs in the groundwater is detected by gas chromatography every 2 hours to observe the purification effect. If the purification effect is found to be unsatisfactory, parameters such as the gas flow rate of the pneumatic pump and the aeration temperature can be further optimized. For example, the intake pressure of the pneumatic pump is finely changed between 0.2-0.4 MPa, or the aeration temperature is precisely adjusted between 70-90° C. to ensure that the groundwater purification meets the expected target. In addition, the connection of each component of the device is checked every quarter, such as pressure testing of pipe joints to check the sealing performance, and the operation stability of the pneumatic pump is checked every month to timely detect and solve potential problems.

Through the above precise device design and strict operation control, efficient groundwater aeration and purification are realized. The tail gas internal circulation system effectively reduces the operation cost, avoids environmental pollution caused by tail gas emission. The stable groundwater circulation and optimized aeration process continuously reduce VOCs in the aquifer and improve the groundwater quality. The precise monitoring and adjustment measures ensure the stable operation of the system, extend the service life of the device, and provide a reliable, economical and efficient solution for in-situ groundwater purification.

### Embodiment 2: Reagent Dosing While Aerating to Realize Collaborative Use of Multiple Technologies

According to the pollution situation of groundwater, appropriate repair reagents are selected. When the main pollutants in the water are benzene series, an appropriate amount of potassium permanganate is prepared as an oxidation-type reagent and added to the reagent storage tank of the ground reagent dosing device 4. The reagent storage tank is made of stainless steel, and the inner wall is coated with a high-quality anti-corrosion coating to prevent the reagent from corroding the tank body. The storage tank is equipped with a stirrer, and the rotation speed of the stirrer can be adjusted between 50-100 rpm to ensure the uniformity of the reagent. The metering pump in the ground reagent dosing device 4 is a high-precision metering pump with a flow accuracy of ±1%, which is connected with the reagent storage tank and the reagent dosing pipe 3. The inlet of the reagent dosing pipe 3 in the integrated pneumatic pump is located at the bottom of the gas-liquid mixing chamber. A backflow prevention structure composed of a stainless steel check valve and a polytetrafluoroethylene inclined baffle is provided at the inlet. The check valve has good sealing performance, and the surface of the baffle is smooth to prevent the mixture from flowing back.

The fan 7, the gas phase extraction device 8, and the ground tail gas treatment device 6 are started according to the steps of Embodiment 1 to make the system enter the tail gas internal circulation state. The rotation speed of the fan 7 is stable at 1000 rpm, and the pneumatic pump is ready to receive the power source for work.

When the reagent is selected to be carried out synchronously with aeration, the solenoid valve in the reagent dosing device is started. According to the computer program setting, the opening size of the solenoid valve is adjusted to make the ratio of the reagent flow rate in the reagent dosing pipe 3 to the gas flow rate in the pneumatic pump 1:8. While the fan 7 extracts the polluted gas to the tail gas treatment device, the reagent is injected into the pneumatic pump through the dosing pipe under the action of negative pressure. In the pneumatic pump, the reagent is fully mixed with groundwater and air, and then the mixed gas-liquid mixture is ejected at high speed from the nozzle. The ejected mixture of reagent, groundwater, and air seeps back into the original formation under the dual action of hydraulic pressure and air pressure. Under the action of hydraulic circulation, efficient dosing and mixing of the reagent are realized, and aeration treatment is carried out at the same time. In this process, the mixing time of the reagent in the groundwater and air is not less than 10 minutes to ensure that the oxidation reaction is fully carried out. And multiple oxidation-reduction potential sensors with an accuracy of ±10 mV are set at different positions to monitor the progress of the oxidation-reduction reaction, so as to accurately adjust the reagent dosing amount.

If the reagent is selected to be dosed separately, the valve between the tail gas device and the pneumatic pump is closed, and the fan 7 is started to extract ambient air. At this time, the rotation speed of the fan 7 is increased to 1300 rpm, and the ambient air is injected into the well to pump the groundwater and reagent to the upper screen section. Then, under the action of pressure, the mixed reagent and groundwater are quickly discharged from the well pipe to accelerate the reagent dosing process. When the reagent is a reduction-type reagent, an appropriate amount of acidic regulator is added to the groundwater extraction well 2 before dosing, and the pH value change is monitored in real time by a pH sensor with an accuracy of ±0.1 pH to ensure that the groundwater pH value is accurately adjusted to 4 to improve the reduction reaction efficiency.

In the process of collaborative treatment of reagent dosing and aeration, the change of VOCs concentration in the groundwater is continuously monitored by an online monitor, the change of reagent concentration and operation parameters of the system are monitored by chemical analysis. According to the monitoring results, parameters such as reagent dosing amount and aeration intensity are timely adjusted to achieve the best purification effect. For example, if the VOCs concentration in a certain area is found to decrease slowly, the reagent dosing amount can be appropriately increased or the aeration temperature can be increased. The access amount of high-pressure steam or high-temperature air is controlled by adjusting the flow regulating valve on the pneumatic pump access pipe 5 to maintain the aeration temperature at 40° C. When high-pressure steam is accessed, the steam pressure is 0.3 MPa, and when high-temperature air is accessed, the air temperature is 150° C.

The sealing performance of the pneumatic pump is checked once every six months, the blockage of the filter screen 202 is checked once a month, and the adsorption effect of the activated carbon adsorption tank is detected once every two months. After the system has been in operation for a period of time, all components of the device are comprehensively checked, and the worn or failed components are timely replaced according to the inspection results to ensure the long-term stable operation of the system and realize the effective purification of groundwater. At the same time, in the whole process, the surrounding environment is closely observed for any abnormal changes, such as soil color, smell, etc., to ensure that the system operation is environmentally friendly and does not produce secondary pollution. In addition, the treated groundwater is tracked and monitored for a long time to evaluate the durability of the repair effect.

This embodiment realizes the efficient collaboration of aeration and reagent treatment through precise reagent dosing control and diversified dosing modes. The combined application of multiple reagents and treatment technologies enhances the treatment capacity for complex pollution and adapts to a wider range of groundwater pollution scenarios. Strict system monitoring and maintenance measures ensure the long-term stable operation of the system. While effectively purifying groundwater, it is environmentally friendly and has a lasting repair effect, providing a flexible, efficient and sustainable solution for groundwater repair.

For those skilled in the art, it is obvious that the present application is not limited to the details of the above exemplary embodiments, and can be implemented in other specific forms without departing from the spirit or basic characteristics of the present application. Therefore, from any point of view, the embodiments should be regarded as exemplary and non-restrictive. The scope of the present application is defined by the appended claims rather than the above description, and therefore it is intended to include all changes within the meaning and scope of the equivalents of the claims. Any reference sign in a claim should not be construed as limiting the claim involved.

What is claimed is:

1. An in-situ purification integrated device for volatile organic compounds (VOCs) in groundwater, comprising
an in-situ air stripping-aeration-reagent dosing integrated pneumatic pump, a groundwater extraction well, a reagent dosing pipe, a ground reagent dosing device, a pneumatic pump access pipe, a ground tail gas treatment device, a fan, and a gas phase extraction device;
wherein the in-situ air stripping-aeration-reagent dosing integrated pneumatic pump is gas-driven, an air inlet of the in-situ air stripping-aeration-reagent dosing integrated pneumatic pump is connected to the fan through a pipeline, the fan is connected to the ground tail gas treatment device through the pipeline to receive treated tail gas as a power source;
an end of the reagent dosing pipe is connected to the ground reagent dosing device, and another end of the reagent dosing pipe is communicated with the in-situ air stripping-aeration-reagent dosing integrated pneumatic pump, and a reagent dosing rate is controlled by an opening size of a solenoid valve in the ground reagent dosing device, and a control signal of the solenoid valve is generated and transmitted by a computer program;
the pneumatic pump access pipe is connected to the in-situ air stripping-aeration-reagent dosing integrated pneumatic pump, and is connected to a high-temperature air source, a flow regulating valve is provided on the pneumatic pump access pipe; and
the ground tail gas treatment device is connected to each extraction well pipe through the pipeline, and is internally provided with an activated carbon adsorption tank filled with columnar activated carbon with a particle size of 3-5 mm, and the gas treated by the activated carbon adsorption tank is pressurized and heated by the fan and then pumped back into the in-situ air stripping-aeration-reagent dosing integrated pneumatic pump.

2. The in-situ purification integrated device for VOCs in groundwater according to claim 1, wherein a bottom end of the in-situ air stripping-aeration-reagent dosing integrated pneumatic pump is provided with an air access end, and an inside of the in-situ air stripping-aeration-reagent dosing integrated pneumatic pump is sequentially provided with a negative pressure suction section, a throat gradual change section, and a high-pressure jet mixing section from bottom to top;
an outer surface of the in-situ air stripping-aeration-reagent dosing integrated pneumatic pump is provided with a liquid phase suction port, and the liquid phase suction port is communicated with the negative pressure suction section;
a left end of the in-situ air stripping-aeration-reagent dosing integrated pneumatic pump is provided with a first pipeline connector, and the first pipeline connector is connected to the reagent dosing pipe;
a bottom end of the air access end is provided with a second pipeline connector, and the second pipeline connector is connected to the pneumatic pump access pipe; and
a check valve is provided inside the first pipeline connector, and the check valve allows the reagent to flow unidirectionally into a mixing chamber to prevent gas-liquid mixture in the mixing chamber from flowing back to the reagent dosing pipe.

3. The in-situ purification integrated device for VOCs in groundwater according to claim 1, wherein the groundwater extraction well is a stainless steel double-layer special well pipe, an inner layer of the groundwater extraction well is a 304 stainless steel slotted pipe where slots are spirally distributed and a slot width is 0.1-0.5 mm, an outer layer of the groundwater extraction well is a stainless steel wire mesh structure, and a space between the inner layer and the outer layer is filled with crushed stones and quartz sand with a particle size of 2-3 mm;
a middle barrier is provided at a middle position of the groundwater extraction well to divide a well pipe into upper and lower parts;
a middle barrier is made of rubber and closely fits an inner wall of the well pipe, and the integrated pneumatic pump is provided in a lower layer of the well pipe, and a filter screen is provided in an upper layer of the groundwater extraction well; and
the filter screen is made of stainless steel and a mesh aperture is 0.1-0.5 mm, and the filter screen is connected to the gas phase extraction device through the pipeline.

4. The in-situ purification integrated device for VOCs in groundwater according to claim 3, wherein a thickness of the middle barrier is 5-10 cm, and an upper surface and a lower surface of the middle barrier are respectively provided with annular sealing grooves, and sealing rings are provided in the sealing grooves, and a thickness of the filter screen is 10-15 cm, and the filter screen is formed by stacking multiple layers of stainless steel wire meshes, and the mesh aperture of each layer of wire mesh gradually decreases from the inside close to the well pipe to the outside.

5. The in-situ purification integrated device for VOCs in groundwater according to claim 1, wherein an anti-corrosion protective layer is provided outside the groundwater extraction well, and the anti-corrosion protective layer is an epoxy resin coating with a thickness of 0.5-1.5 mm.

6. An application method of an in-situ purification integrated device for VOCs in groundwater, comprising:
starting a fan and a gas phase extraction device to extract the volatile polluted gas in a groundwater to a ground tail gas treatment device; wherein the treated tail gas is pressurized and heated by the fan and then transported to the in-situ air stripping-aeration-reagent dosing integrated pneumatic pump as a power source, and an automatic pressure compensation device of an extraction pipeline of the fan extracts ambient air when starting, and automatically closes after the air volume is balanced, to start an tail gas internal circulation; during an ambient air extraction stage, a rotation speed of the fan is 1000-1500 rpm, and when switched to the tail gas internal circulation, the rotation speed of the fan is adjusted to 800-1200 rpm;
high-pressure gas entering a pneumatic pump to generate negative pressure, wherein groundwater in a lower layer of the groundwater extraction well is extracted to an upper layer through an air stripping extraction pipe; the groundwater is mixed with gas at high speed in a pump body and then ejected at high speed by a nozzle to realize in-well aeration, and a filter screen in an upper layer of the well pipe intercepts water vapor, and pollutants volatilize and are extracted by an air extraction device to enter a tail gas treatment device for cyclic treatment; water circulates under gravity and micro-positive pressure, during in-well aeration process, an upward flow rate of water in the groundwater extraction well is 1-3 m/s by adjusting a gas flow rate of the pneumatic pump, wherein during in-well aeration, an access amount of high-temperature air is controlled by adjusting a flow regulating valve on a pneumatic pump access pipe to maintain an aeration temperature at 30-50° C., and a temperature of the accessed high-temperature air is 100-200° C.;
during a circulation of the groundwater, a residence time in an aquifer is 2-5 hours each time after aeration and circulation treatment, and after each circulation treatment, a concentration of VOCs in the groundwater is detected, and when the concentration is reduced below a set threshold, a purification treatment of the area is stopped;
according to repair requirements, preparing repair reagents in a ground reagent dosing device, and adjusting a reagent dosing rate by controlling an opening size of a solenoid valve; where the reagent dosing is carried out simultaneously with aeration, that is, the reagent is injected into the pneumatic pump through a dosing pipe under the action of negative pressure, mixed with groundwater and air, and then ejected, and seeps back into an original formation under the action of hydraulic pressure and air pressure to realize reagent dosing and mixing; when carried out simultaneously, a ratio of the reagent flow rate in the reagent dosing pipe to a gas flow rate in the pneumatic pump is 1:5 to 1:10, and when carried out separately, closing a valve between the tail gas device and the pneumatic pump, and the fan extracting ambient air and injecting it into the well to pump the groundwater and reagent to an upper screen section and then quickly discharging it under pressure to accelerate reagent dosing, and when carried out separately, a flow rate of ambient air extracted by the fan is 1.2-1.5 times the gas flow rate during normal tail gas circulation.

7. The application method of the in-situ purification integrated device for VOCs in groundwater according to claim 6, wherein during a separate reagent dosing process, when the reagent is an oxidation-type reagent, the reagent completes at least 1-2 cycles in a lithological formation around a circulation well to ensure uniform and sufficient reagent dosing;
when the reagent is a reduction-type reagent, an appropriate amount of acidic regulator is added to the groundwater extraction well before dosing to adjust a pH value of the groundwater to 3-5 to improve a reduction reaction efficiency;
during an entire application process, an activated carbon adsorption tank in the ground tail gas treatment device is regularly regenerated, with a regeneration cycle of 1-3 months;
a regeneration method is hot air purging, the hot air temperature is 120-150° C., and a purging time is 2-4 hours.

8. The application method of the in-situ purification integrated device for VOCs in groundwater according to claim 6, wherein before starting the device, pretreating a formation around the groundwater extraction well is pretreated comprises injecting a cleaning agent, the cleaning agent is a surfactant solution with a concentration of 0.5%-2%;
during an application process, a change of a groundwater level is monitored in real time, and operating parameters of the fan and the pneumatic pump are adjusted according to a water level change;
during a reagent dosing process, an appropriate reagent type and dosing sequence are selected according to the water quality and pollutant components of the groundwater; and
when the water contains multiple VOCs pollutants, a special reagent for a main pollutant is dosed first, and then an auxiliary reagent is dosed.
